(19) United States
(12) Patent Application Publication
(10) Pub. No.: US 2019/0080359 A1
(43) Pub. Date: Mar. 14, 2019

(54) ADVERTISING SYSTEM THAT RAISES MONEY FOR CHARITY

(71) Applicants: KEVIN GAGNON, MONTREAL (CA); OMAR ASCOFARE, MONTREAL (CA)

(72) Inventors: KEVIN GAGNON, MONTREAL (CA); OMAR ASCOFARE, MONTREAL (CA)

(21) Appl. No.: 15/699,399

(22) Filed: Sep. 8, 2017

(51) Int. Cl. G06Q 30/02

(52) U.S. Cl. CPC G06Q 30/0273

(57) ABSTRACT

Advertisements on popular websites and computer applications have become a very popular approach for modern advertisers looking to reach younger audiences. However, there is not really an accurate way to determine whether the advertisements have been effective in reaching the intended target audience. Furthermore, there is no system on the market today that gets the users involved in the advertising process, and gives the users the ability to leverage their online attention towards advertisers to benefit society, e.g. a selected charity. Accordingly, an advertisement system that involves the user in the selection of the advertisements, and provides the user a vested interest in the advertisement process by providing a donation to a selected charity would be a useful and welcome approach.

### TECHNICAL FIELD

The present invention relates to an advertising system, and in particular to an advertising system in which users raise money for charity.

### BACKGROUND

A key challenge for advertisers is to grab the viewer's attention, and to keep their attention long enough to make their pitch. Conventional advertising methods, such as newspapers and TV commercials, are no longer an effective means to reach a broad spectrum of potential buyers, in particular to reach the highly sought after younger demographics. Modern advertisers have attempted to position advertisements on popular websites and applications. Accordingly, users are resigned to the fact that they receive free services in exchange for advertisements. However, there is no accurate way to determine whether the advertisements have been effective in reaching the intended target audience. Moreover, there is nothing on the market today that gives the user control over what kind and how many advertisements are presented to them, while at the same time to leveraging their online attention towards advertisers to benefit society, e.g. a selected charity.

An object of the present invention is to overcome the shortcomings of the prior art by providing an advertisement system that provides the user with a vested interest in the advertisement process, which results in a donation given to a charity in return for the user viewing an advertisement.

### SUMMARY OF THE INVENTION

Accordingly, an embodiment of the present invention relates to a method of generating revenue for charity by leveraging a user's attention towards online advertising comprising:

providing an advertisement distribution program (ADP) for user authorized installation onto a user's computer, the ADP capable of providing an advertisement from an advertiser to the user at a predetermined frequency;
providing a profile for the user to populate from the ADP in response to installing the ADP;
providing the user with the advertisement on the user's computer via the ADP at the predetermined frequency;
charging a standard fee from the advertiser or their representative for providing the advertisement to the user; and
allocating a percentage of the standard fee to a charity.

Another aspect of the present invention relates to a method of advertising comprising:

providing an advertisement distribution program (ADP) for user authorized installation onto a user's computer, the ADP capable of providing an advertisement to the user at a predetermined frequency of no more than twice per day;
providing a profile for the user to populate from the ADP in response to installing the ADP, the profile including user preferences and a preferred charity;
determining if the user has received an advertisement within the predetermined frequency;
providing the user with an advertisement based on the user's preferences on the user's computer via the ADP, if the user has not received an advertisement within the predetermined frequency;
charging a standard fee from the advertiser or their representative for providing the advertisement to the user; and
allocating a percentage of the standard fee to the preferred charity.

### BRIEF DESCRIPTION OF THE DRAWINGS

The invention will be described in greater detail with reference to the accompanying drawings which represent preferred embodiments thereof, wherein:

FIG. 1 is a schematic diagram of an embodiment of an advertising/charity system in accordance with the present invention;

FIGS. 2a and 2b illustrate a profile page dropdown provided by the advertisement distribution program for a browser extension and a desktop application, respectively, of the advertising/charity system of FIG. 1;

FIGS. 3a and 3b illustrate a user interest list dropdown provided by the advertisement distribution program for a browser extension and a desktop application, respectively, of the advertising/charity system of FIG. 1;

FIGS. 4a and 4b illustrate a charity list dropdown provided by the advertisement distribution program for a browser extension and a desktop application, respectively, of the advertising/charity system of FIG. 1;

FIGS. 5a, 5b and 5c illustrate an advertisement dropdown provided by the advertisement distribution program for a browser extension, a desktop application, and a mobile phone application respectively, of the advertising system of FIG. 1;

FIG. 6 illustrates the advertisement dropdown of FIGS. 5a, 5b and 5c;

FIG. 7 illustrates a charity sign-up page of the advertising/charity system of FIG. 1; and

FIG. 8 illustrates the payment system of the advertising/charity system of FIG. 1.

### DETAILED DESCRIPTION

While the present teachings are described in conjunction with various embodiments and examples, it is not intended that the present teachings be limited to such embodiments. On the contrary, the present teachings encompass various alternatives and equivalents, as will be appreciated by those of skill in the art.

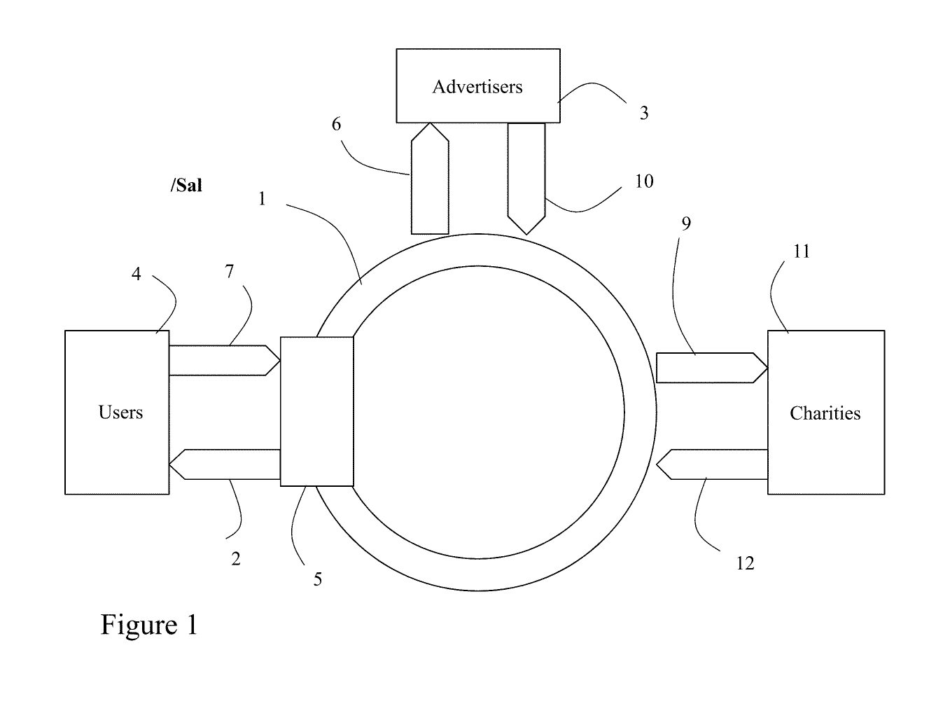

With reference to FIG. 1, an embodiment of the advertising/charity system in accordance with the present invention includes a main controller platform 1, which provides advertisements 2 from advertisers 3 to users 4 via an advertisement distribution program (ADP) 5 downloaded on the user's computer or mobile device, such as an extension on the user's browser or an app on the user's desktop or home screen, thereby giving the advertisers 3 desired exposure 6. The main controller platform 1 includes suitable computer hardware and software, stored on non-transitory memory and executable by a controller, to carry out the steps of the advertising system. The term “user's computer” will hereinafter be used to refer to any device the user may use to access the internet, e.g. desktop, laptop, tablet, watch or mobile device. The users' attention 7 is enhanced by the fact that a donation 9, e.g. a percentage equal to or greater than 75%, of the total fee 10 paid by the advertisers 3 to the main controller platform 1 for the advertisements 2, goes to one or more charities 11. The user's attention 7 may also have enhanced by the users' ability to identify what kinds of advertisements 2 they like and/or what kind of purchases they are looking to make. The charities 11 are also provided with an opportunity to advertise their images 12 to the users 4 and the advertisers 3, in particular via specific projects, which will be hereinafter discussed. Accordingly, the users 4 feel involved and even satisfied about receiving the advertisement 2, and thereby more likely to pay attention to the advertisement 2.

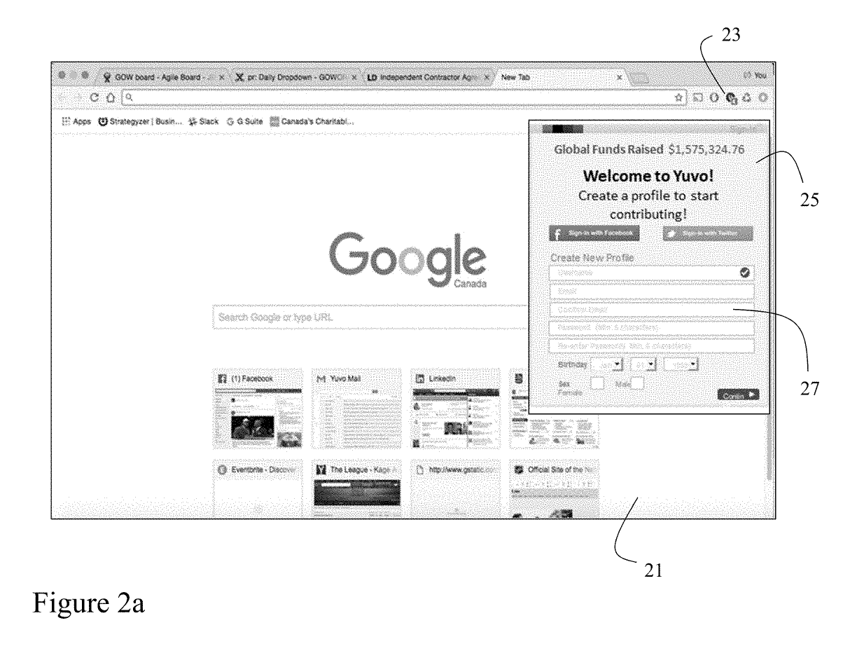

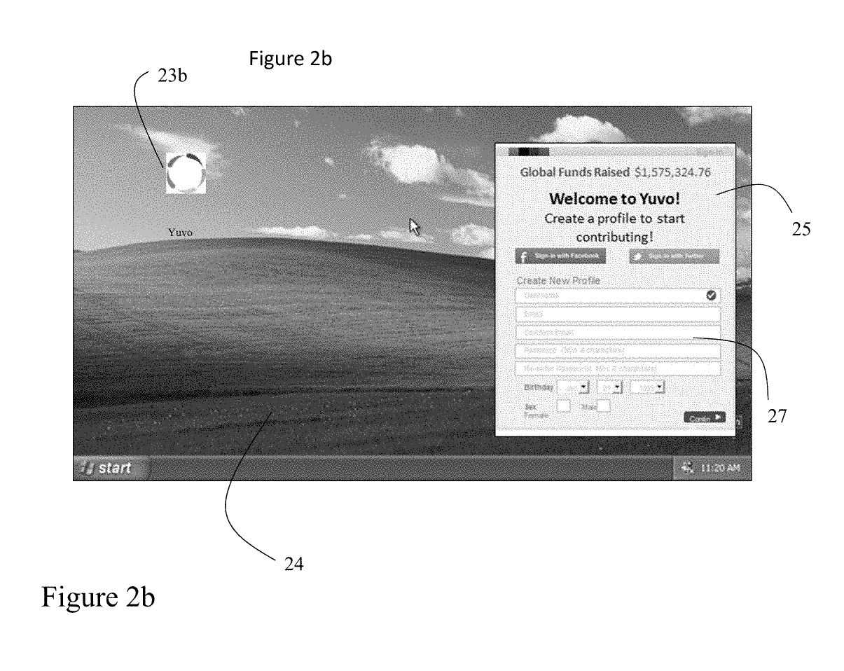

With reference to FIGS. 2a and 2b, to start the process, a user 4, for example using their internet browser 21, e.g. Google Chrome, Mozilla and Safari, may navigate to the computer's app store or the corresponding browser's marketplace, e.g. Google Chrome Marketplace, Mozilla Add-ons, and Safari Extensions, or a website of the main platform 1 or associated company, where the main platform 1 provides the advertisement distribution program 5, e.g. browser extension, desktop application or mobile application, i.e. a software program, for installation and storage in non-transitory memory on the user's computer. Once the advertisement distribution program 5 is downloaded and/or installed on the user's computer, the advertisement distribution program 5 may create an icon 23a, which will appear in the user's browser 21, or an icon 23b, which will appear in the user's desktop or mobile device home screen 24 to begin a sign-up phase. Alternatively, if the extension or application has already been installed or downloaded on the user's computer, e.g. by a computer, software or browser supplier, the user 4 may simply opt in to the service, and the system will be available.

A dropdown or profile page 25 will be provided by the advertisement distribution program 5, which will appear asking the user 4 to create a profile 27. The profile 27 may include the typical basic user information, e.g. name and email address, but the profile 27 may also include more specific information, such as sex, age and geographical location, to facilitate subsequent steps in the process.

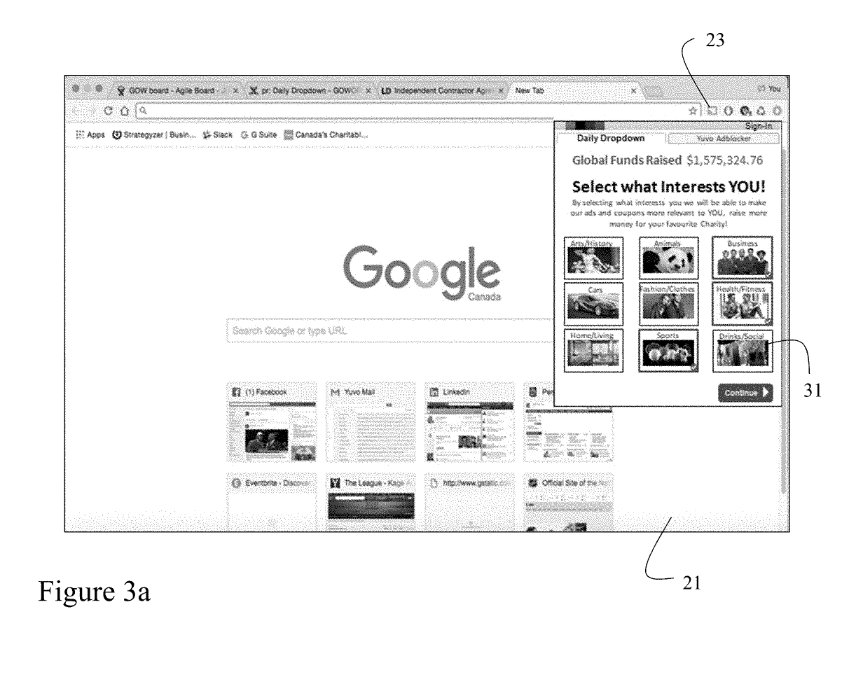

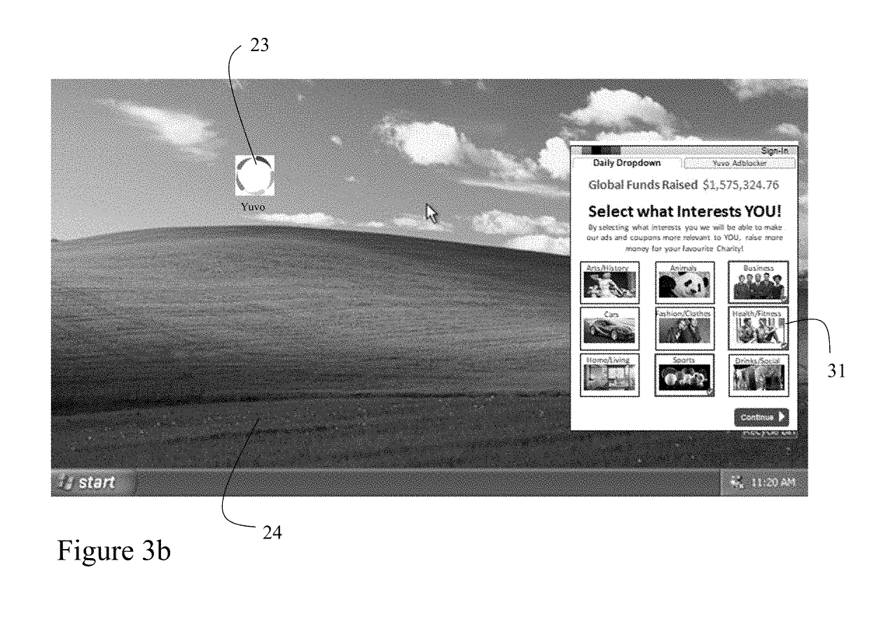

To enhance the advertisement process even further, and to ensure that the user 4 receives more relevant advertisements, the next step may involve the user 4 being provided by the advertisement distribution program 5 with a list of interests 31, e.g. in a dropdown menu on their browser 21 or their home screen 24, from which the user 4 may select and prioritize what interests them. For example, as illustrated in FIGS. 3a and 3b, the list of interests 31 may include History, the Arts, Animals, Business, Cars, Fashion, Cloths, Health/Fitness, Home/Living, Sports, and Food/Drink. Each item on the main list of interests 31 may include sub-lists to enable the user 4 to select even more specific interests, which enables the advertisements 2 to be specifically targeted to each user 4. Alternatively, or in addition, the advertisement distribution program 5 may be able to track the user's browser search history, e.g. products or services searched, to facilitate selection of the advertisements 2, i.e. based on the search history, for the individual user 4.

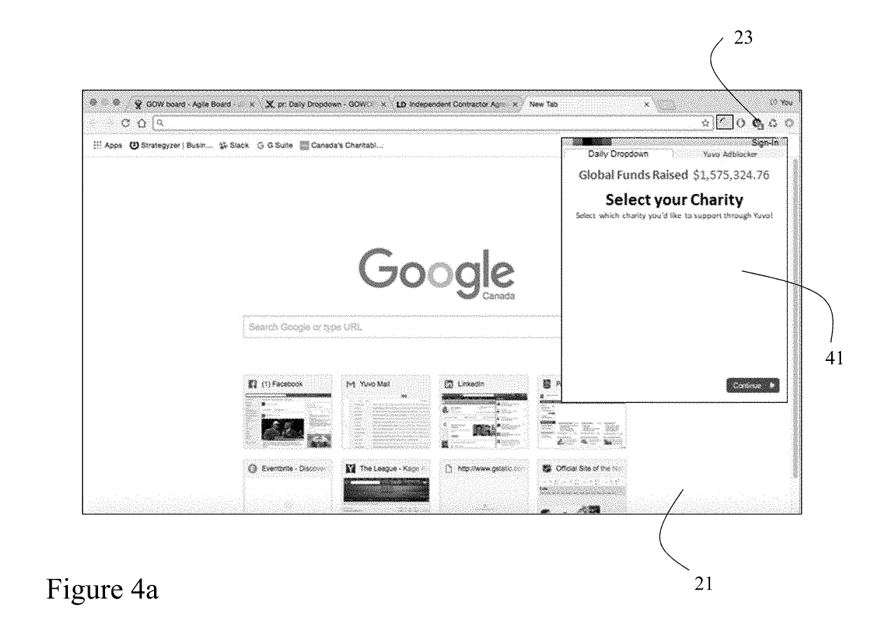

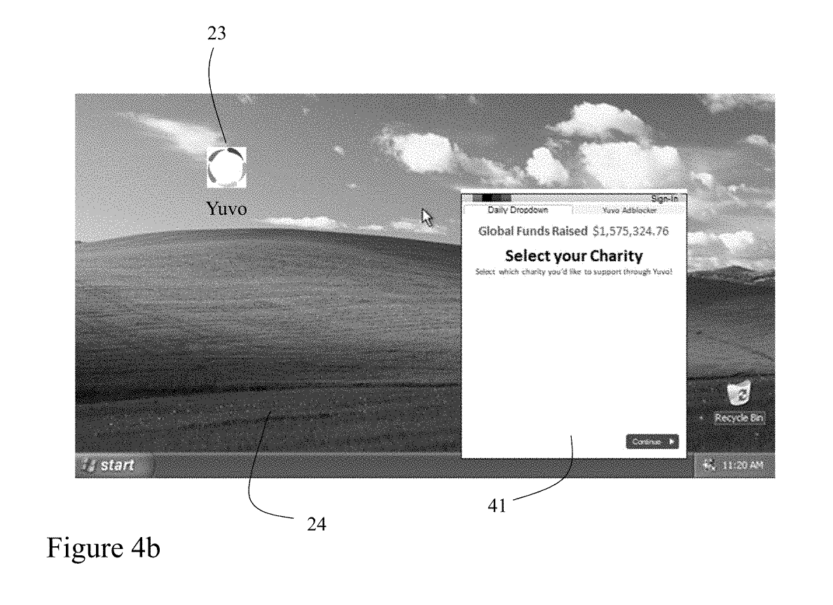

With reference to FIGS. 4a and 4b, to further involve the user 4, the advertisement distribution program 5 may then provide the user 4 with a list of charities 41, e.g. in a drop down menu on their browser 21 or their home screen 24, from which the user 4 may select which charity they wish to support with the donation 9 from the overalls fees 10. The user 4 may be provided with the list of charities, as well as a list of projects within each charity they may want support. The advertisement distribution program 5 may also offer the user 4 to select multiple charities and multiple projects to support. Alternatively, the charity or charities 11 to which the donation 9 is allocated may be selected automatically by the main platform controller 1 based on other information and preferences from the profile 27 of the user 4, e.g. geographical proximity of the user 4 to the charity 11, previous charities 11 selected by the user 4, age of the user 4, sex of the user 4, interests of the user 4, for example nature, animals or sports.

The advertisement distribution program 5 may then provide the user 4 with a menu to select how often they wish to receive a dropdown advertisement 51, as hereinafter discussed. Typically, the advertisement distribution program 5 will provide a single dropdown advertisement 51 each day, i.e. a basic frequency, but the user 4 may choose to receive the dropdown advertisement 51 more frequently, e.g. no more than two or three times per day, or less frequently, e.g. no more than once per week. An additional fee may be included in the total fee 10, to the advertisement company, and therefore in the donation 9, by the main platform 1, when the user 4 receives the dropdown advertisement 51 more frequently than the basic frequency, e.g. for every additional viewing by the user 4 of the advertisement 51 an additional fee is charged.

At some time during the sign-up phase, the advertisement distribution program 5 may provide the user 4 with the ability, e.g. via a drop-down menu or sign-in page, to create a username and password, so that any of the previously submitted information to be changed or amended to suit future desires of the user 4, e.g. change frequency, charity 11 or charity projects.

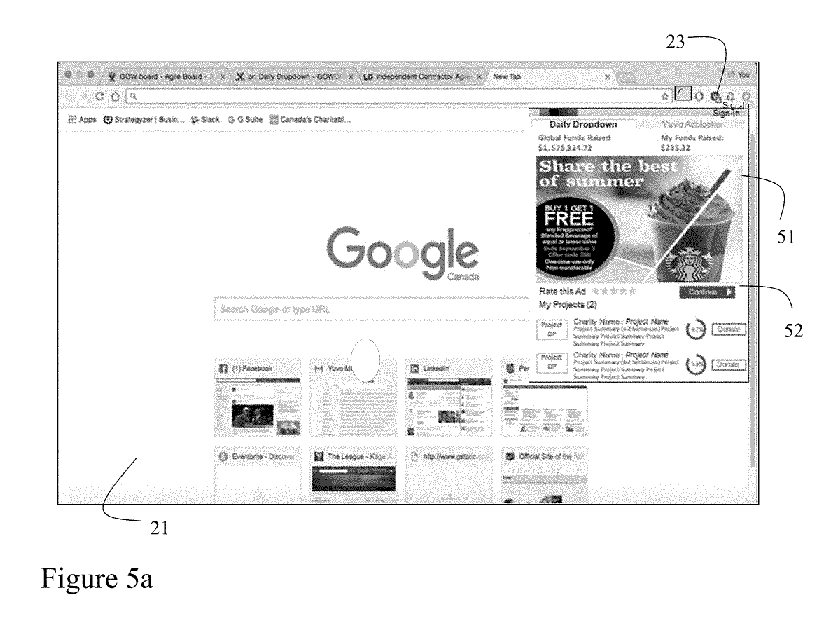

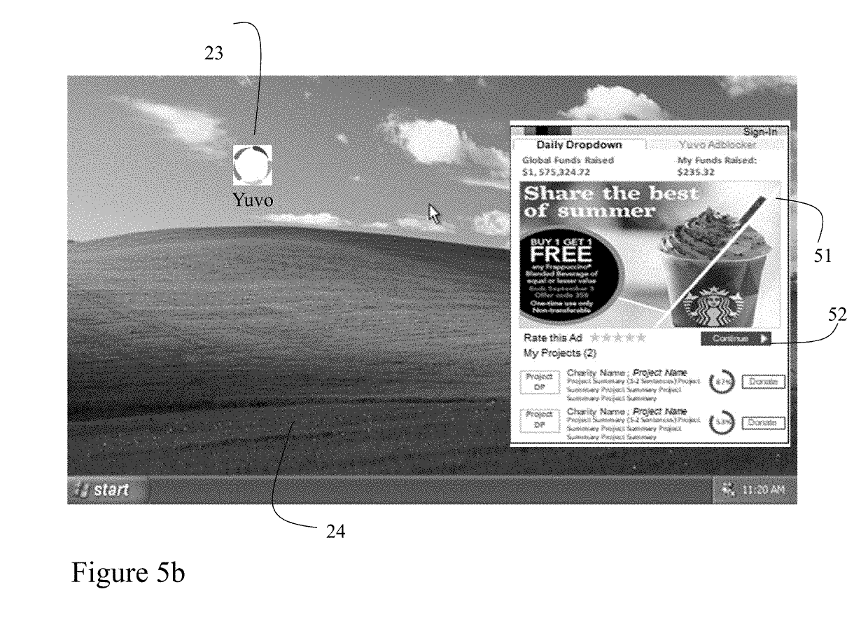

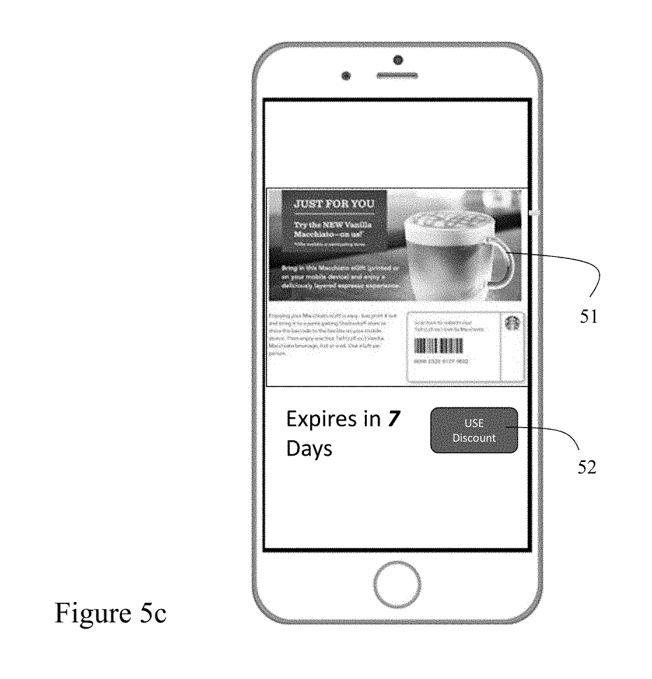

The next phase comprises the advertisement/interaction steps, beginning with the advertisement distribution program 5 providing the user 4 with their first dropdown or pop up advertisement 51, see FIGS. 5a, 5b and 5c. Typically, the advertisement distribution program 5 will provide the user 4 with one dropdown or pop-up advertisement 51 per day while on their computer, e.g. desktop/laptop or mobile device; however, providing more or less frequent advertisement dropdowns or pop ups 51 are possible, as herein before discussed. The advertisement distribution program 5 may deliver the advertisement 51 as soon as the user 4 turns on their computer, as soon as the user 4 connects to the internet, as soon as the user 4 activates their browser 21, or after a predetermined time that the user 4 has conducted one of the aforementioned activities. The advertisement distribution program 5 may receive updated advertisements 51 whenever the user 4 connects their computer device to the internet. The advertisements 51 may be updated after a predetermined number of views, e.g. 5, and/or after a predetermined time period, e.g. every day or week, regardless of the number of views Typically, the advertisements 51 may be sent to the user's computer from a remote online source, so the user 4 will not receive their timely advertisement 51 unless they connect to the internet; however, the advertisements 51 may be stored along with acknowledgement the advertisements 51 were viewed with the advertisement distribution program 5 for a predetermined time period, e.g. up to one week, in case the user 4 does not go back online.

The frequency of the advertisement should not be disruptive to the user 4, should disappear after a predetermined short period of time, e.g. less than 30 seconds, preferably less than 10 seconds, and should never be continuous, e.g. longer than one minute. Alternatively, or in addition, the user 4 should have the ability to remove, e.g. delete or close, the advertisement 51 whenever desired immediately or after a predetermined time, e.g. more than 5 seconds. The dropdown or pop-up advertisement 51 may include or be in the form of a discount coupon or gift certificate for the advertiser's wares or services to be downloaded for printing or viewing on a mobile device.

In a preferred embodiment, the advertisement application program 5 may provide the user 4 with the ability, e.g. via continue links 52 on the dropdown or pop up advertisement 51 to related websites, to engage and interact with the dropdown or pop up advertisement 51. Ideally, additional fees will also be paid by the advertisers 3, and therefore provided to the designated charities 11 by the main platform 1, the more the user 4 interacts with the advertisement 51.

For example: a standard fee may be charged by the main platform 1 and paid by the advertisers 3 for each view of the advertisement 51, e.g. a cost per impression (CPM). A second additional fee may be charged by the main platform 1 and paid by the advertiser 3 for each advertisement 51 that is interacted with via one or more of the continue links 52, e.g. cost per click (CPC). A third fee may be charged by the main platform 1 and paid by the advertiser 3 for each time a user 4 provides feedback to the advertiser 3 about the advertisement 51 or the product in general via the continue links 52, e.g. cost per feedback (CPF). A fourth fee may be charged by the main platform and paid by the advertiser each time a user 4 purchases the wares or services of the advertiser 3 via the continue links 52 provided on the advertisement 51, e.g. cost per conversion (CPCon). A coupon or gift certificate may be provided as the advertisement 51 or in addition to the advertisement 51. The coupon or gift certificate may be transferred by the advertisement distribution program 5 directly to the desktop or mobile device of the user 4 or by using some other form of e-commerce.

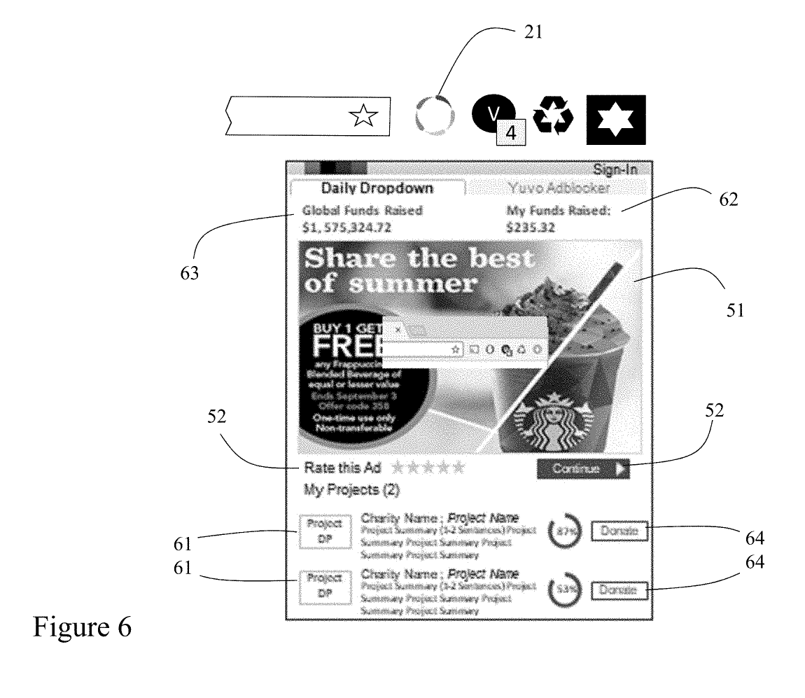

As illustrated in FIG. 6, within the advertisement dropdown or pop up 51 the user 4 may be provided with a list of the charities 11 and the particular projects 61 within each charity 11, that they are currently funding. Providing details of a particular project 61 provides another level of interest and interactivity between the user 4 and the charities 11. Striving towards and reaching specific goals, i.e. fully funded projects 61, will provide the user with a greater interest in the specific charity 11, and even greater desire to receive another advertisement 51. Moreover, the advertisement dropdown or pop up 51 may also display how much the user 4 has raised, e.g. My Funds Raised 62, and the total amount of funds raised globally, e.g. Global Funds Raised 63. The user 4 may also able to make a monetary donation of their own to a specific project 61 by clicking the “Donate” link 64.

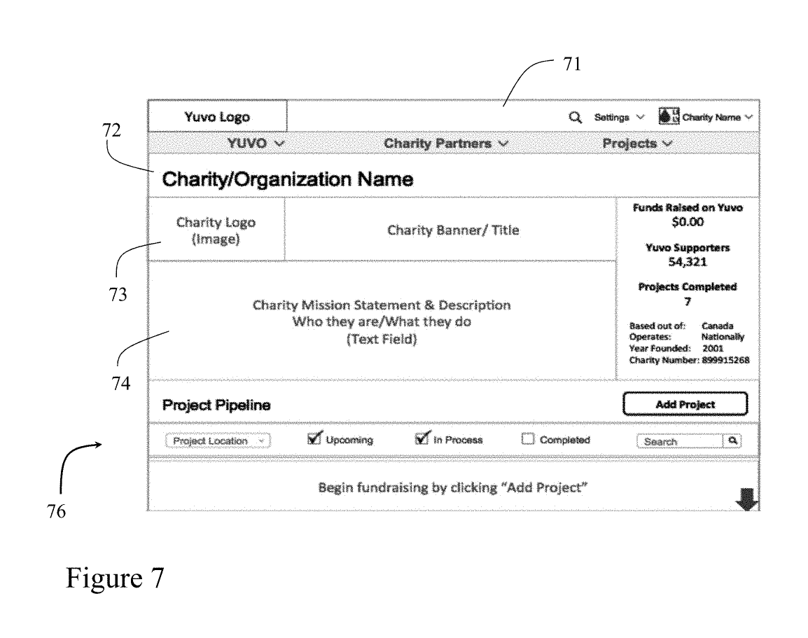

With reference to FIG. 7, the main platform 1 may provide each charity 11 with a Charity Portal/Profile 71, which is a profile page for each charity 11 where they can display their name 72 and logo 73, their mission statement 74, as well as a user interface 76 to add the various projects 61 and the details thereof that they are working on and have completed with the assistance of the Advertisement Distribution Program 5. The charity portal 71 may also display other details 77 about the charity 11, such as funds raised, number of supporters, number of projects completed, nationality, year founded, and charity number. Some or all of the information on the charity portal 71 may be accessible to the users 4 via one of the continue links 52 from the advertisement dropdown or pop up 51 or directly from the website of the main platform 1 to provide the image 12 of the charity 11.

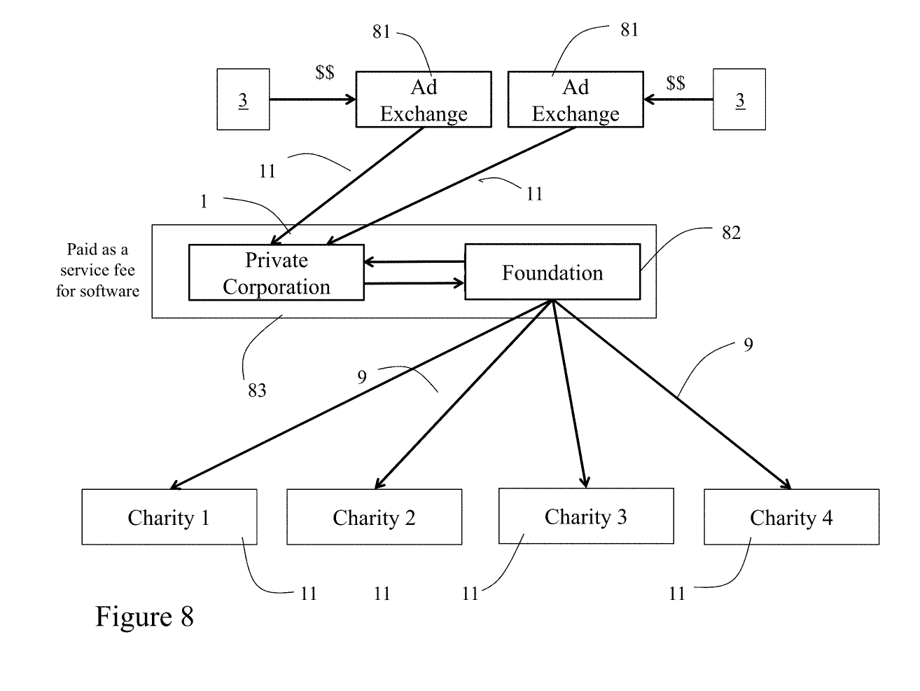

With reference to FIG. 8, the steps of collecting the total fee 10 from the advertisers 3, and allocating the donation 9, comprising a percentage of the total fee 10 to one or more charities 11, includes: the advertisers 3 engaging one or more of a plurality of advertisers, advertising agencies, networks or exchanges 81, who negotiate, e.g. bid on or agree upon, the total fee 10 for each drop down or pop up advertisement 51, typically sold in large lots, and any subsequent interaction to be paid to the main platform 1. The main platform 1 may then distribute the donations 9 to the various charities 11 based on the user's 4 choices and interactions. The main platform 1 may be subdivided into a charitable foundation 82, which collects the total fees 10 and pays the donations 9, and a private company 83, which operates and maintains the advertisement distribution program 5. The donation may be over 50%, preferably 50%-95%, more preferably over 75%, and typically between 70%-80% of the total fee 10.

The advertisement process may include the following steps:

Determining when the user 4 is eligible to receive an advertisement 2 or 51, e.g. after the predetermined time period (24 hours) of not receiving one according to their profile 27, the daily dropdown ad space 51 becomes eligible or “sellable”, which causes the advertisement distribution program 5 to send a signal to the main platform 1 or results in an alert being provided in the main platform 1. The determination may be conducted via an exchange of signals via a communication network, e.g. the internet, between the main platform 1 and the advertisement distribution program 5, one of which maintains a timetable of advertisements received by the user 4. Ideally, each time the user 4 connects to the communication network the advertisement distribution program 5 communicates with the main platform 1 to determine if the user 4 is overdue to receive an advertisement 2. Furthermore, while the user 4 is connected to the communication network, the advertisement distribution program 5 may communicate with the main platform 1 when the user 4 is due to receive their next advertisement 2. The communications may be initiated by either the advertisement distribution program 5 or the main platform 1.

The main platform 1 then signals the Ad Exchange or Ad Network 81 to indicate that the ad space 51 for the user 4 is up for sale.

An automatic auction is then executed between advertisers 3 and/or their Ad Exchanges 81 until the highest bidder is awarded the ad space 51. The automatic auction may be based on criteria of the Ad Exchange 81 based on the profile 27 of the user 4, e.g. the more specific the user's profile 27 (age, sex, interests) meets the Ad Exchange's criteria, the more the Ad Exchange 81 is willing to offer for their ad space 51.

The image or video ad 3 is then transmitted from the Ad Exchange 81 through an ad server at the main platform 1 to the advertisement distribution program 5, which displays the advertisement 3 in the user's dropdown or pop up window 51

The advertisement distribution program 5 may then: 1) determine and signal the main platform 1 that the advertisement 51 has been opened; 2) identify what interactions are made by the user 4 with the advertisement 51, e.g. has it been rated, has it been clicked, has it been saved to their mobile device, etc.; and determine and signal the main platform 1 that the advertisement 51 has been closed.

The main platform 1 then determines what overall fee 10 to charge the advertiser 3 based on the interactions of the user 4.

Finally, the main platform 1 or the charitable foundation 82 set up by the main platform 1 allocates a percentage 9 of the overall fee 10 to the predetermined charity 11.

The foregoing description of one or more embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A method of generating revenue for charity by leveraging a user's attention towards online advertising comprising:
providing an advertisement distribution program (ADP) for user authorized installation onto the user's computer, the ADP capable of providing an advertisement from an advertiser to the user at a predetermined frequency;
providing a profile for the user to populate from the ADP in response to installing the ADP;
providing the user with the advertisement on the user's computer via the ADP at the predetermined frequency;
charging a standard fee from the advertiser or their representative for providing the advertisement to the user; and
allocating a percentage of the standard fee to a charity.

2. The method according to claim 1, wherein
the profile includes user information and preferences; and
wherein the advertisement is based on at least one of the user's information and preferences.

3. The method according to claim 1, wherein
the user's information and preferences include a desired charity; and
wherein the step of allocating includes allocating to the user's desired charity.

4. The method according to claim 1 wherein
the step of providing the user with an advertisement comprises determining if the user has
received an advertisement within the predetermined frequency.

5. The method according to claim 4, wherein
the step of providing the ADP comprises providing an extension for an internet browser of the user; and
the step of providing the user with an advertisement comprises: providing the user with a drop down advertisement when the user opens the internet browser and connects to the internet, when the user has not received an advertisement within the predetermined frequency.

6. The method according to claim 4, wherein
the step of providing an advertisement distribution program comprises providing a desktop application for a computer of the user; and
wherein the step of providing the user with an advertisement comprises: providing the user with a pop up advertisement when the user connects to the internet, when the user has not received an advertisement within the predetermined frequency.

7. The method according to claim 4, wherein
the step of providing an advertisement distribution program comprises providing a home screen application for a mobile device of the user; and
wherein the step of providing the user with an advertisement comprises: providing the user with a pop up advertisement when the user connects to the internet, when the user has not received an advertisement within the predetermined frequency.

8. The method according to claim 1, wherein
the predetermined frequency comprises no more than once per day.

9. The method according to claim 8, further comprising:
providing the user with the ability to increase the predetermined frequency;
charging a first additional fee to the advertiser or their representative for providing the advertisement to the user at the increased predetermined frequency; and
allocating a percentage of the first additional fee to the charity.

10. The method according to claim 1, wherein
the advertisement includes a continue link to interact with the advertiser.

11. The method according to claim 10, further comprising:
charging a second additional fee to the advertiser or their representative for the user interacting with the advertisement; and
allocating a percentage of the second additional fee to the charity.

12. The method according to claim 10, wherein
the continue link includes a link to a website of the advertiser or associated company.

13. The method according to claim 10, further comprising:
charging a third additional fee to the advertiser or their representative for the user purchasing wares or services from the website of the advertiser or associated company; and
allocating a percentage of the third additional fee to the charity.

14. The method according to claim 1, further comprising:
charging a fourth additional fee to the advertiser or their representative for the user purchasing wares or services from a website of the advertiser or a related company; and
allocating a percentage of the fourth additional fee to the charity.

15. The method according to claim 1, further comprising
listing in the advertisement how much the user has raised for the charity.

16. The method according to claim 3, wherein
the user preferences include a list of projects with the desired charity; and
the step of allocating includes donating to a desired project from the list of projects from the desired charity.

17. The method according to claim 16, further comprising
listing in the advertisement how much money has been raised by the user for a specific project of the user's desired charity.

18. The method according to claim 1, wherein
the advertisement includes a coupon or gift certificate from the advertiser or a related company.

19. The method according to claim 1, further comprising:
determining when the predetermined frequency has expired;
initiating an automatic auction between advertisers to determine a new standard fee for providing a new advertisement to the user;
receiving the new advertisement from the advertiser winning the auction;
transmitting the new advertisement to the advertisement distribution program; and
displaying the new advertisement on the user's computer.

20. A method of advertising comprising:
providing an advertisement distribution program (ADP) for user authorized installation onto a user's computer, the ADP capable of providing an advertisement to the user at a predetermined frequency of no more than twice per day;
providing a profile for the user to populate from the ADP in response to installing the ADP, the profile including user preferences and a preferred charity;
determining if the user has received an advertisement within the predetermined frequency;
providing the user with an advertisement based on the user's preferences on the user's computer via the ADP, if the user has not received an advertisement within the predetermined frequency;
charging a standard fee from the advertiser or their representative for providing the advertisement to the user; and
allocating a percentage of the standard fee to the preferred charity.
